(19) United States
(12) Patent Application Publication
(10) Pub. No.: US 2014/0157197 A1
(43) Pub. Date: Jun. 5, 2014

(54) DISPLAY APPARATUS AND METHOD FOR PROVIDING USER MENU THEREOF

(71) Applicant: SAMSUNG ELECTRONICS CO., LTD., Suwon-si (KR)

(72) Inventors: Seung-hwan LEE, Seoul (KR); Dong-ryun SEOK, Seoul (KR); Thach Ba NGUYEN, Suwon-si (KR)

(73) Assignee: SAMSUNG ELECTRONICS CO., LTD., Suwon-si (KR)

(21) Appl. No.: 14/097,911

(22) Filed: Dec. 5, 2013

(30) Foreign Application Priority Data
Dec. 5, 2012 (KR) 10-2012-0140592

(51) Int. Cl. G06F 3/0482; G06F 3/0484

(52) U.S. Cl. CPC G06F 3/0482; G06F 3/04842
USPC 715/811

(57) ABSTRACT

A display apparatus and a method for providing a user menu are provided. The method for providing a user menu of a display apparatus includes displaying an electronic manual to explain a setting item of the display apparatus and, if a command to add one setting item from among a plurality of setting items included in the electronic manual is input, adding the setting item to a user menu. Accordingly, a user may recognize the functions provided by the display apparatus better and more accurately and add a setting item corresponding to a frequently-used function to the user menu.

### CROSS-REFERENCE TO RELATED APPLICATION

This application claims priority from Korean Patent Application No. 10-2012-0140592, filed in the Korean Intellectual Property Office on Dec. 5, 2012, the disclosure of which is incorporated herein by reference in its entirety.

### BACKGROUND

1. Field

Aspects of the exemplary embodiments relate to a display apparatus and a method for providing a user menu thereof, and more particularly, to a display apparatus which provides a user menu including at least one setting item which is frequently used by a user, and a method for providing a user menu thereof.

2. Description of the Related Art

As a display apparatus which displays an image, such as a television, adopts various functions, the display apparatus includes a plurality of setting items to set the various functions. For example, the prior art television includes a plurality of setting items to view a general broadcast image, such as an image setting item, an audio setting item, a broadcast setting item, and so on, but more recent televisions include not only setting items to view a general broadcast image, but also various items such as an external apparatus setting item, a 3D function setting item, an Internet function setting item, and so on.

However, in spite of the increasing number of setting items, the prior art display apparatus configures and provides menus in mass when the display apparatus is initially manufactured regardless of the usage by users. In addition, as the number of setting items increase, the menus are provided in various hierarchical structures, making it difficult for users to find a desired menu easily.

Further, various functions are adopted by a display apparatus while users are not familiar with the terms of the display apparatus, and thus users may find it difficult to determine which functions are provided by each setting item based on the title of each of the setting items.

### SUMMARY

An aspect of the exemplary embodiments relate to a display apparatus which may generate a user menu using an electronic manual so that users may recognize the functions provided by the display apparatus better and more accurately in order to add a setting item corresponding to a desired function to the user menu and a method for providing a user menu thereof.

A method for providing a menu of a display apparatus according to an exemplary embodiment comprising displaying an electronic manual to explain a setting item of the display apparatus and, if a command to add at least one setting item from among a plurality of setting items included in the electronic manual is input, adding the setting item to the menu.

The displaying may comprise determining a number of times that the display apparatus is turned on when power is applied to the display apparatus, and if it is determined that the display apparatus is turned on for a first time, displaying the electronic manual.

The displaying may comprises, when the display apparatus is turned on for a first time, displaying a menu selection user interface (UI) to determine whether to generate the menu, and when a command to generate the menu is input through the menu selection UI, displaying the electronic manual.

The electronic manual may include a setting item description area to explain a plurality of setting items included in the electronic manual and an adding item to add the at least one setting item to the menu.

The displaying may comprise, when a command to display the electronic manual is input while the display apparatus displays an image, displaying the electronic manual.

The method may further comprise, when a predetermined button on a remote controller to control the display apparatus is manipulated, displaying the menu.

A display apparatus according to an exemplary embodiment comprising a display which displays an electronic manual to explain a plurality of setting items of the display apparatus, a user command inputter configured to receive a command, and a controller which, if a command to add at least one setting item from among the plurality of setting items included in the electronic manual is input through the user command inputter, is configured to control to add the setting item to a menu. The apparatus may further comprise a storage unit which stores the menu.

The controller may determine a number of times that the display apparatus is turned on when power is applied to the display apparatus, and when the display apparatus is turned on for a first time, controls the display to display the electronic manual.

The controller, when the display apparatus is turned on for the first time, may control the display to display a menu selection user interface (UI) to determine whether to generate the menu and, when a command to generate the menu is input through the menu selection UI, to display the electronic manual.

The electronic manual may include a setting item description area to explain the plurality of setting items included in the electronic manual and an adding item to add the setting item to the menu.

The controller, when a command to display the electronic manual is input through the user command inputter while the display apparatus displays an image, controls the display to display the electronic manual.

The user command inputter may be a remote controller, and the controller, when a predetermined button on the remote controller is manipulated, may control the display to display the menu.

### BRIEF DESCRIPTION OF THE DRAWINGS

The above and/or other aspects of the exemplary embodiments will be more apparent with reference to the accompanying drawings, in which:

FIG. 1 is a view illustrating configuration of a display apparatus briefly according to an exemplary embodiment;

FIG. 2 is a view illustrating configuration of a display apparatus in detail according to an exemplary embodiment;

FIGS. 3 to 5 are views provided to explain a method for providing a user menu using an electronic manual when a display apparatus is turned on for the first time according to an exemplary embodiment;

FIG. 6 is a view provided to explain a method for providing a user menu using an electronic manual while an image is being displayed according to another exemplary embodiment; and

FIG. 7 is a flowchart provided to explain a method for providing a user menu of a display apparatus according to an exemplary embodiment.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

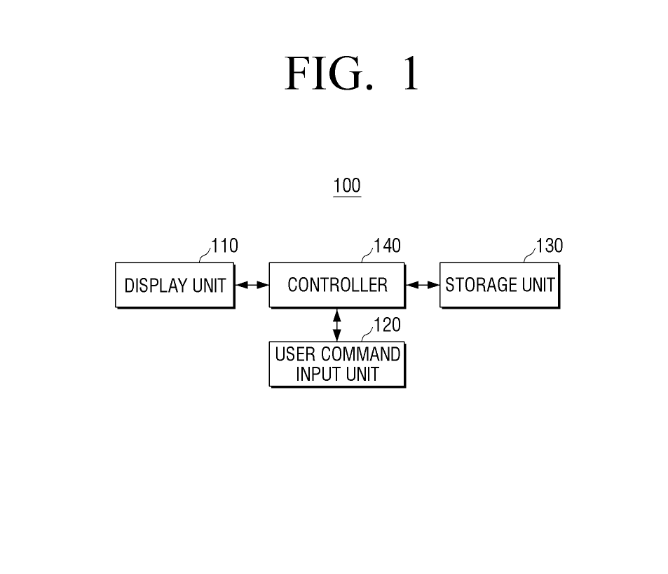

FIG. 1 is a view illustrating configuration of a display apparatus briefly according to an exemplary embodiment. As illustrated in FIG. 1, a display apparatus 100 comprises a display unit 110, a user command input unit 120, a storage unit 130 and a controller 140. In this case, the display apparatus 100 may be realized as a smart television, but this is only an example. The display apparatus 100 may be realized as another display apparatus such as a monitor, a projector, a tablet PC, a smart phone and so on.

The display unit 110 displays image data under the control of the controller 140. In particular, the display unit 110 may display a user menu including an electronic manual which explains the function and setting of the display apparatus 100 and setting items corresponding to the function and setting of the display apparatus 100 which are used frequently by users.

The user command input unit 120 receives a user command to control the display apparatus 100. In particular, the user command input unit 120 may receive a user command to display an electronic manual, a user command to add at least one of the setting items included in the electronic manual to the user menu, and a user command to display the user menu.

In this case, the user command input unit 120 may be realized as a remote controller, but this is only an example. The user command input unit 120 may be realized as another input apparatus to control the display apparatus 100 such as a touch panel, a pointing device, and so on.

The storage unit 130 stores various data and programs to control the display apparatus 100. In particular, the storage unit 130 includes information regarding a user menu which comprises setting items selected by a user input.

The controller 140 controls overall operations of the display apparatus 100 according to a user command input through the user command input unit 120. In particular, if a command to add a setting item from among a plurality of setting items included in the electronic manual is input through the user command input unit 120 while the electronic manual is displayed, the controller 140 may control the storage unit 130 to add the corresponding setting item to the user menu.

Specifically, if a predetermined condition is satisfied, the controller 140 may control the display unit 110 to display the electronic manual. For example, if the power of the display apparatus 100 is turned on, the controller 140 may identify the number of times the display apparatus 100 is turned on. If the number of times the display apparatus 100 has been turned on is once, the controller 140 may control the display unit 110 to display the electronic manual when the display apparatus 100 is turned on for the first time. In another example, if a user command to display the electronic manual is input through the user command input unit 120, the controller 140 may control the display unit 110 to display the electronic manual.

In this case, the electronic manual may include a setting item description area to explain a plurality of setting items included in the electronic manual and an adding item to add the setting item to the user menu.

If a command to add at least one setting item from among a plurality of setting items included in the electronic manual is input while the electronic manual is displayed, the controller 140 may control the storage unit 130 to add the corresponding setting to the user menu. In this case, the command to add the setting item may be a user command to select the added item included in the electronic manual.

As described above, by adding a setting item in the user menu through the electronic manual, a user may add a setting item corresponding to a frequently-used function to the user menu while understanding the functions of a display apparatus better and more accurately.

As described above, if a user command to display the user menu is input after adding a setting item to the user menu (for example, a command to press a predetermined button included in a remote controller), the controller 140 may display a user menu where the added setting item is included.

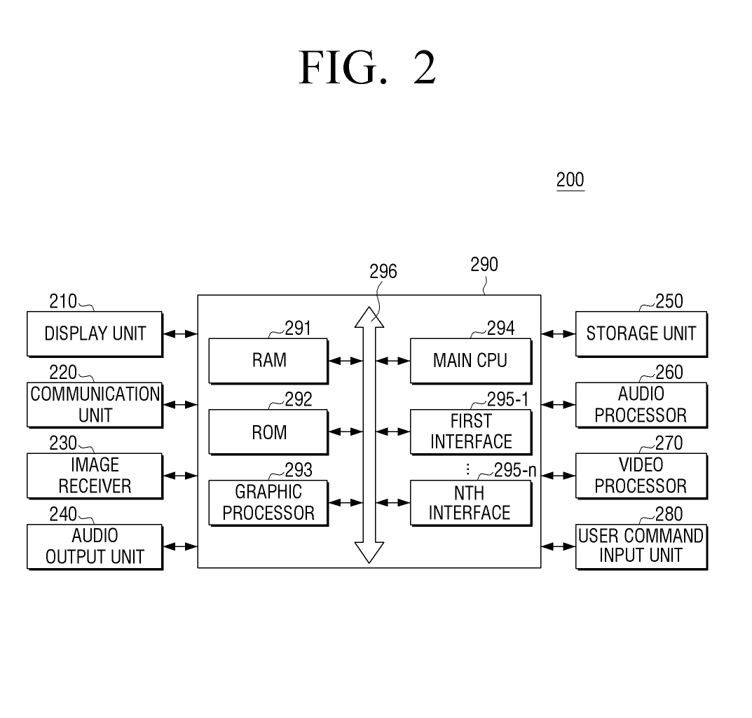

Hereinafter, exemplary embodiments will be explained in further detail with reference to FIGS. 2 to 6. FIG. 2 is a block diagram illustrating a configuration of a display apparatus 200 in detail according to an exemplary embodiment. As illustrated in FIG. 2, the display apparatus 200 comprises a display unit 210, a communication unit 220, an image receiver 230, an audio output unit 240, a storage unit 250, an audio processor 260, a video processor 270, a user command input unit 280, and controller 290.

Meanwhile, FIG. 2 illustrates various components of the display apparatus 200 comprehensively, assuming that the display apparatus 200 is an apparatus having various functions such as the function of communication, the function of receiving broadcast, the function of reproducing a video, a displaying function, and so on. Accordingly, depending on exemplary embodiments, some of the components illustrated in FIG. 2 may be omitted or changed, or other components may be further added.

The display unit 210 displays at least one of a video frame which is generated as the video processor 270 processes image data received from the image receiver 230 and various screens which are generated by a graphic processor 293. In particular, the display unit 210 may display an electronic manual and a user menu generated by the graphic processor 293.

The communication unit 220 performs communication with various types of external apparatuses according to various communication methods. The communication unit 220 may include various communication chips such as a WiFi chip, a Bluetooth chip, a Near Field Communication (NFC) chip, a wireless communication chip, and so on. In this case, the WiFi chip, the Bluetooth chip, and the NFC chip perform communication according to a WiFi method, a Bluetooth method, and an NFC method, respectively. The NFC chip refers to a chip which operates according to an NFC method using 13.56 MHz from among various radio frequency identification (RF-ID) frequencies such as 135 kHz, 13.56 MHz, 433 MHz, 860-960 MHz, and 2.45 GHz. When a WiFi chip or a Bluetooth chip is used, various connection information such as a service set identifier (SSID), a session key, etc. may be transmitted/received first to establish communication, and various information are transmitted/received using the same. The wireless communication chip refers to a chip which performs communication according to various communication standards such as IEEE, Zigbee, 3rd Generation (3G), 3rd Generation Partnership Project (3GPP), Long Term Evolution (LTE), and so on.

The image receiver 230 receives image data through various sources. For example, the image receiver 230 may receive broadcast data from an external broadcast station and receive image data from an external apparatus (for example, a DVD device).

The audio output unit 240 may configure not only various audio data processed by the audio processor 260 but also various alarm sounds and voice messages.

The storage unit 250 stores various modules to operate the display apparatus 200. For example, the storage unit 250 may store software including a base module, a sensing module, a communication module, a presentation module, a web browser module, and a service module. In this case, the base module refers to a basic module which processes a signal transmitted from each hardware included in the electronic apparatus 200 and transmits it to an upper layer module. The sensing module refers to a module which collects information from various sensors and analyzes and manages the collected information, and may include a face recognition module, a voice recognition module, a motion recognition module, an NFC recognition module, and so on. The presentation module refers to a module which configures a display screen, and may include a multimedia module to reproduce and output multimedia contents and a UI rendering module which performs UI and graphic processing. The communication module refers to a module to perform communication with outside. The web browser module refers to a module which access a web server by performing web-browsing. The service module refers to a module which includes various applications to provide various services.

As described above, the storage unit 250 may include various program modules, but some of the various program modules may be omitted, changed, or added depending on types and characteristics of the display apparatus 200. For example, if the above-described display apparatus 200 is realized as a tablet PC, the base module may further comprise a location determination module which determines a GPS-based location, and the sensing module may further comprise a sensing module which senses a user operation.

In particular, the storage unit 250 may store information regarding a user menu which includes a setting item selected by a user.

The audio processor 260 is a component which processes audio data. The audio processor 260 may perform various processing with respect to audio data such as decoding, amplifying, noise filtering, and so on. The audio data processed by the audio processor 260 may be output to the audio output unit 240.

The video processor 270 is a component which processes image data received from the image receiver 230. The video processor 270 may perform various image processing with respect to image data such as decoding, scaling, noise filtering, frame rate conversion, resolution conversion, and so on.

The user command input unit 280 receives a user command to control the overall operations of the display apparatus 200. In this case, the user command input unit 280 may be realized as a remote controller, but this is only an example. The user command input unit 280 may be realized as another input apparatus capable of controlling the display apparatus 200 such as a touch panel, a pointing device, and so on.

In particular, the user command input unit 280 may receive a user command to display an electronic manual, a user command to ad one of a plurality of setting items included in the electronic manual to a user menu, and a user command to display the user menu.

The controller 290 controls the overall operations of the display apparatus 200 using various programs stored in the storage unit 250.

As illustrated in FIG. 2, the controller 290 may comprise a random access memory (RAM) 291, a read-only memory (ROM) 292, a graphic processor 293, a main central processing unit (CPU) 294, first to nth interface 295-1˜295-n, and a bus 296. In this case, the RAM 291, the ROM 292, the graphic processor 293, the main CPU 294, and the first to the nth interface 295-1˜295-n may be connected to each other through the bus 296.

The ROM 292 stores a set of commands for system booting. If a turn-on command is input and thus, power is supplied, the main CPU 294 copies an O/S stored in the storage unit 250 in the RAM 291 according to a command stored in the ROM 292 and executes the O/S to boot the system. Once the system booting is completed, the main CPU 294 copies various application programs stored in the storage unit 250 in the RAM 291 and performs various operations by executing the application programs copied in the RAM 291.

The graphic processor 293 generates a screen including various objects such as an icon, image, text, etc. using an operator (not shown) and a renderer (not shown). The operator calculates property values such as coordinates, shape, size, color, etc. of a screen where each object is displayed according to a layout of a screen using a control command received from the user command input unit 280. The renderer generates a screen of various layouts including an object based on the property values calculated by the operator. The screen generated by the renderer is displayed within a display area of the display unit 210.

The main CPU 294 performs booting using the O/S stored in the storage unit 250 by accessing the storage unit 250. In addition, the main CPU 294 performs various operations using various programs, contents, data, and etc. stored in the storage unit 250.

The first to nth interface 295-1 to 295-n is connected to the above-described various components. One of the interfaces may be network interface which is connected to an external apparatus through network.

In particular, if a predetermined condition is satisfied, the controller 290 may display an electronic manual on the display unit 210. In this case, the electronic manual is a manual in the form of text to explain the functions provided by the display apparatus and the setting items which can be changed to users.

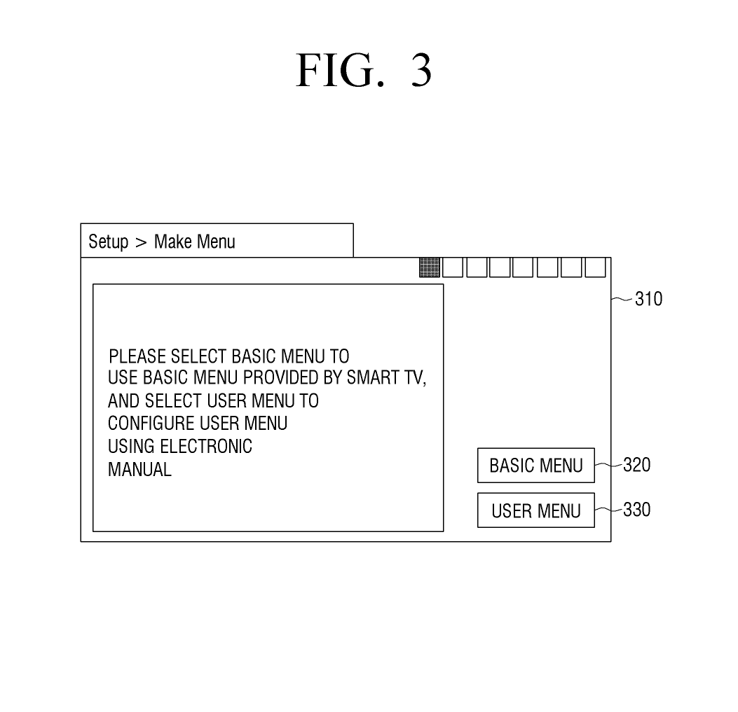

According to an exemplary embodiment, if the display apparatus 200 is turned on, the controller 290 counts the number of times that the display apparatus 200 is turned on. If the number of times the display apparatus 200 has been turned on is “1”, that is, the display apparatus 200 is turned on for the first time, the controller 290 may control the display unit 210 to display a user menu selection UI 310 to ask whether to generate a user menu as illustrated in FIG. 3.

In this case, if an item 320 to generate a basic menu, the controller 290 does not generate a user menu and instead, may store a basic menu including the setting items which are stored at the time of manufacturing in the storage unit 250.

On the other hand, if an item 330 to generate a user menu is selected, the controller 290 may control the display unit 210 to display an electronic manual 400. In this case, the electronic manual 400 may display setting items corresponding to the functions of the display apparatus 200 which can be set by users in a hierarchical structure. For example, the electronic manual may provide setting items such as “screen”, “audio”, “communication”, etc. as upper menus, and provide setting items such as “mode”, “brightness”, “contrast”, “color adjustment” as sub-menus of “screen”.

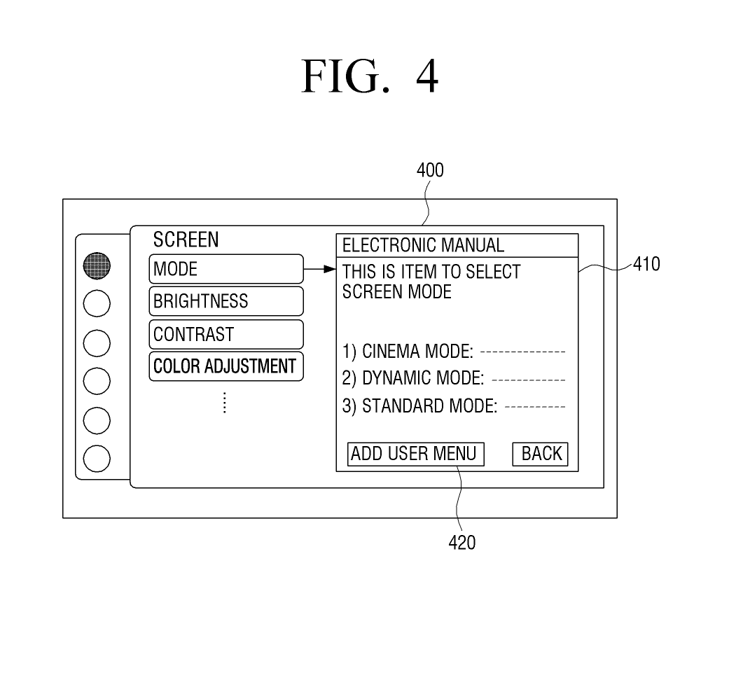

Meanwhile, in the exemplary embodiment illustrated in FIG. 4, the electronic manual 400 includes setting items having a hierarchical structure, but this is only an example. The electronic manual 400 may provide setting items in another form. For example, the electronic manual 400 may include setting items on every page in the form of an electronic book so that different setting items may be selected by turning pages.

If one setting item is selected through the user command input unit 280, the controller 290 may control the display unit 210 to display a setting area for setting items where a detailed description regarding a selected setting item is provided and an adding item to add a corresponding setting item to a user menu. For example, if a setting item to set “mode” of “screen” is selected through the user command input unit 280, the controller 290 may control the display unit 210 to display a setting item setting (description) area 410 to provide detailed description regarding a setting item to set “mode” of “screen” and an adding item 420 to add the setting item to set “mode” of “screen” to a user menu as illustrated in FIG. 4.

If a user command to add a selected item to a user menu, the controller 290 may control the storage unit 250 to add and store the selected setting item in the storage unit 250. For example, as illustrated in FIG. 4, if the adding item 420 to add the setting item to set “mode” of “screen” provided in the electronic manual 400 to a user menu is selected, the controller 290 may control the storage unit 250 to add the setting item to set “mode” of “screen” to the user menu and store it in the storage unit 250.

As described above, when the display apparatus 200 is turned on for the first time, an electronic manual is displayed and a user menu is generated using the electronic manual so that users may generate the user menu including a plurality of setting items to set desired functions of the display apparatus 200 by viewing the electronic manual.

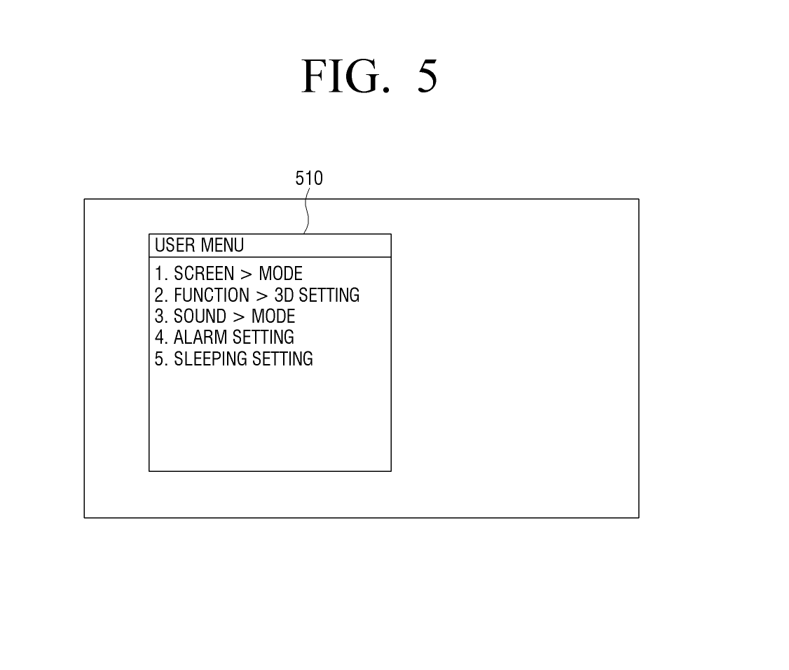

In addition, a user command to display a user menu is input later, the controller 290 may control the display unit 210 to display the user menu. For example, if a predetermined button (for example, a user menu generation button) on a remote controller is selected, the controller 290 may control the display unit 210 to display the user menu as illustrated in FIG. 5.

According to another exemplary embodiment, if a user command to display an electronic manual (for example, a user command to press a predetermined button on a remote controller) is input through the user command input unit 280 while an image provided by the image receiver 230 is being displayed on the display unit 210, the controller 290 may control the display unit 210 to display the electronic manual.

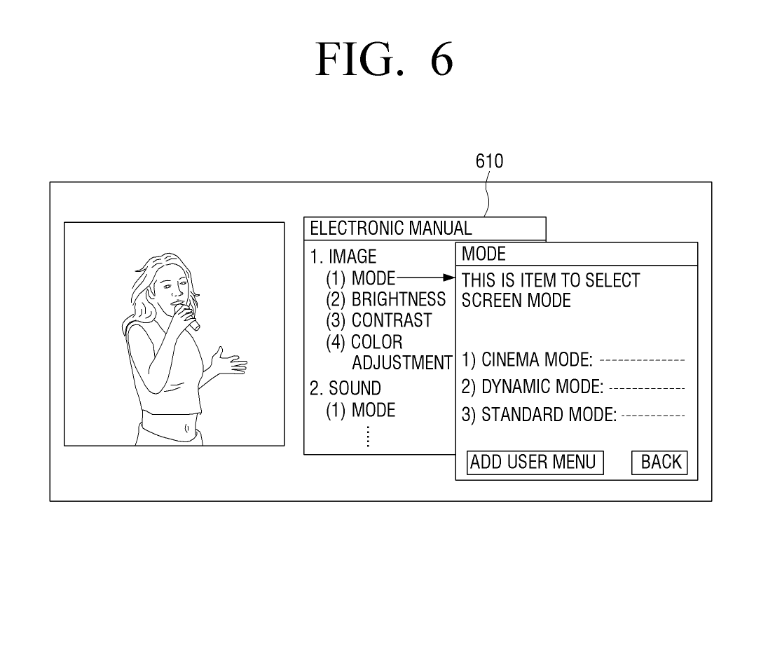

In this case, the controller 290 may control the display unit 210 to display an electronic manual 610 on one portion of a screen where the image is being displayed as illustrated in FIG. 6.

When the electronic manual 610 is displayed, the controller 290 may add a setting item to a user menu as illustrated in FIGS. 4 and 5.

As described above, by adding a setting item to a user menu using an electronic manual while an image is being displayed, users may add functions which the users did not feel necessary when the display apparatus was turned on initially, but now feel necessary, to the user menu.

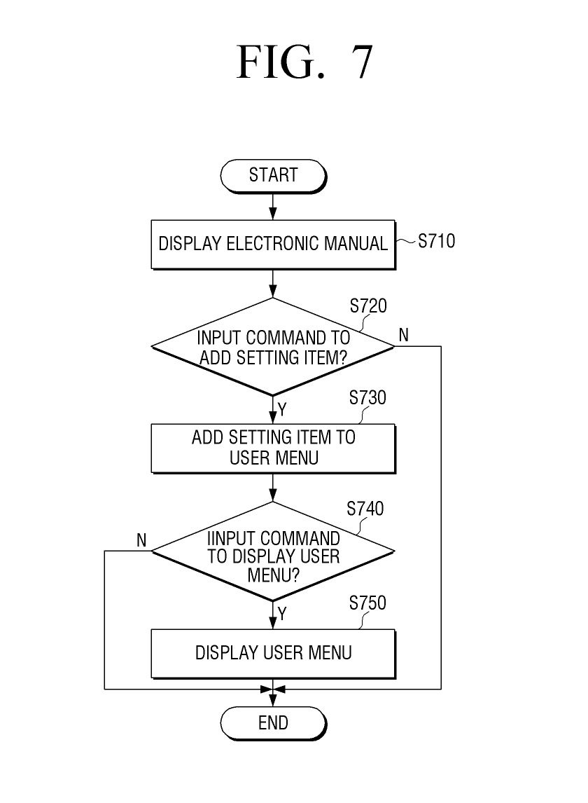

Hereinafter, the method for providing a user menu of the display apparatus 200 will be explained with reference to FIG. 7.

First of all, the display apparatus 200 displays an electronic manual (S710). In this case, the display apparatus 200 may display the electronic manual when the display apparatus 200 is turned on initially and may display an electronic manual when a predetermined user command (for example, a user command to press a predetermined button on a remote controller) is input. In particular, the electronic manual may include a setting item description area to explain a plurality of setting items included in the electronic manual and an adding item to add a setting item to a user menu.

Subsequently, the display apparatus 200 determines whether an adding command regarding a setting item included in the electronic manual is input (S720). In this case, the adding command regarding a setting item may be a user command to select the adding item 420 of a setting item displayed on the electronic manual as illustrated in FIG. 4.

When the adding command regarding a setting item is input (5720-Y), the display apparatus 200 adds the setting item to the user menu (S730).

Subsequently, the display apparatus 200 determines whether a command to display the user menu is input (S740). In this case, a command to display the user menu may be a user command to select a predetermined button on a remote controller.

When a user command to display the user menu is input (5740-Y), the display apparatus 200 displays the user menu (S750). Once the user menu is displayed, users may set desired functions using a setting item included in the user menu.

According to the above-described method for providing a user menu, users may add a setting item corresponding to a frequently-used function to the user menu while understanding the functions of the display apparatus better and more accurately.

Meanwhile, in the above exemplary embodiment, a setting item is added to a user menu using the adding item 420, but this is only an example. A setting menu may be added to a user menu using in other ways. For example, a setting item may be added to a user menu using user voice recognition or motion recognition. Specifically, if a predetermined user voice (for example, “add it to user menu”) or user motion (for example, a rotation command in a counter-clockwise direction) is input while a setting item is displayed on an electronic manual, the controller 290 may add the displayed setting item to the user menu.

Meanwhile, a method for providing a user menu of a display apparatus according to the above various exemplary embodiments may be realized as a program and provided in the display apparatus.

Specifically, a non-transitory computer readable medium storing a program which includes the step of displaying an electronic manual to explain setting items of the display apparatus and the step of adding one setting item to the user menu if a command to add one setting item from among a plurality of setting items included in the electronic manual is input may be provided.

Herein, the non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as a compact disc (CD), digital versatile disc (DVD), hard disk, Blu-ray disk, universal serial bus (USB), memory card, and ROM and provided therein.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A method for providing a menu of a display apparatus, comprising:
displaying an electronic manual to explain a setting item of the display apparatus; and
if a command to add at least one setting item from among a plurality of setting items included in the electronic manual is input, adding the setting item to the menu.

2. The method as claimed in claim 1, wherein the displaying comprises determining a number of times that the display apparatus is turned on when power is applied to the display apparatus, and if it is determined that the display apparatus is turned on for a first time, displaying the electronic manual.

3. The method as claimed in claim 1, wherein the displaying comprises: when the apparatus is turned on for a first time, displaying a menu selection user interface (UI) to determine whether to generate the menu; and
when a command to generate the menu is input through the menu selection UI, displaying the electronic manual.

4. The method as claimed in claim 1, wherein the electronic manual includes a setting item description area to explain the plurality of setting items included in the electronic manual and an adding item to add the at least one setting item to the menu.

5. The method as claimed in claim 1, wherein the displaying comprises, when a command to display the electronic manual is input while the display apparatus displays an image, displaying the electronic manual.

6. The method as claimed in claim 1, further comprising:
when a predetermined button on a remote controller to control the display apparatus is manipulated, displaying the menu.

7. A display apparatus, comprising:
a display which displays an electronic manual to explain a plurality of setting items of the display apparatus;
a user command inputter configured to receive a command; and
a controller which, if a command to add at least one setting item from among the plurality of setting items included in the electronic manual is input through the user command inputter, is configured to control to add the at least one setting item to a menu.

8. The apparatus as claimed in claim 7, wherein the controller determines a number of times that the display apparatus is turned on when power is applied to the display apparatus, and when the display apparatus is turned on for a first time, controls the display to display the electronic manual.

9. The apparatus as claimed in claim 8, wherein the controller, when the display apparatus is turned on for the first time, controls the display to display a menu selection user interface (UI) to determine whether to generate the menu and, when a command to generate the menu is input through the menu selection UI, to display the electronic manual.

10. The apparatus as claimed in claim 7, wherein the electronic manual includes a setting item description area to explain the plurality of setting items included in the electronic manual and an adding item to add the setting item to the menu.

11. The apparatus as claimed in claim 7, wherein the controller, when a command to display the electronic manual is input through the user command inputter while the display apparatus displays an image, controls the display to display the electronic manual.

12. The apparatus as claimed in claim 7, wherein the user command inputter is a remote controller, and
wherein the controller, when a predetermined button on the remote controller is manipulated, controls the display to display the menu.

13. The apparatus as claimed in claim 7, further comprising a storage which stores the menu.
